(19) United States
(12) Patent Application Publication
(10) Pub. No.: US 2002/0120779 A1
(43) Pub. Date: Aug. 29, 2002

(54) Mediation software for delivery of interactive mobile messaging and personalized content to mobile devices

(76) Inventors: Douglas Teeple, Kallua-Kona, HI (US); Randall Adam Snyder, Campbell, CA (US)

Correspondence Address: HOGAN & HARTSON L.L.P., 500 S. GRAND AVENUE, SUITE 1900, LOS ANGELES, CA, 90071-2611, US

(21) Appl. No.: 09/893,323

(22) Filed: Jun. 26, 2001

Related U.S. Application Data
(63) Continuation-in-part of application No. 09/713,757, filed on Nov. 14, 2000.

(51) Int. Cl. G06F 15/16

(52) U.S. Cl. 709/246; 709/230

(57) ABSTRACT

A method and system are provided for presenting data in multiple formats in a subscriber network. A request is received from a small screen device for data over a first network using a first communication protocol. The request is translated from the first communication protocol to a second communication protocol. The request is then forwarded to a sever having the requested data using the second communication protocol. The requested data is received from the sever using the second communication protocol, wherein the requested data is in a first presentation format. The requested data is reformatted in a second presentation format different from the first presentation format.

### CROSS REFERENCE TO RELATED APPLICATION

This Application is a Continuation-In-Part application of, and claims priority from, U.S. patent application Ser. No. 09/713,757 entitled “Method and System for Markup Language Processing for Small Screen Format Mobile Devices” filed on Nov. 14, 2000.

### BACKGROUND OF THE INVENTION

1. Field of the Invention

The present invention relates to a system and method for improved delivery of data, and more particularly, to a system and method for improved delivery of mobile messaging and personalized content.

2. Description of Related Art

Networking technology has developed a large network of networks, referred to as the Internet, which interconnects millions of computers around the world. The Internet allows the transfer of data between any number of computer systems connected to the Internet using the Transmission Control Protocol/Internet Protocol (TCP/IP). Computers responding to service requests from other computers, via the Internet, are commonly referred to as servers, and computers that initiate requests for service from a server are referred to as clients.

The Internet has become very popular in part due to the World Wide Web (WWW), which is a network of links to hypertext documents operating within the Internet. These hypertext documents are referred to as Web documents, Web pages, or hypertext documents. Web documents are embedded with directly accessible connections or links to other documents that create a non-linear way of reading the document. The links are embedded in Web documents as a phrase of text or an image that can be selected and activated by a computer user. Information about the Web documents are controlled and provided by Web servers. At the user's end, a Web client takes the user's requests and passes them on to the Web server.

The Web documents are written with a high level programming language referred to as the Hypertext Markup Language (HTML). Commands of the HTML, hereinafter referred to as tags, provide a variety of functions including, but not limited to, defining special format and layout information in a Web document, embedding images and sound in a Web document, and embedding links to other Web documents.

In general, each Web document is given a “Uniform Resource Locator (URL) which is essentially the address path identifying the server which hosts the desired document plus the location of the document on the server. Using a browser software, an end-user can send a request from a client computer to access a document stored at a particular URL on a server. One popular browser is Netscape Navigator. “Netscape Navigator” is a trademark of the Netscape Communications Corporation. When the server receives the user's request, it sends the requested HTML Web document to the client where the document can be displayed. The communications protocol used in making such a request and in transferring Web documents is the “Hypertext Transfer Protocol” (HTTP).

The Web document is typically displayed to an end-user of a display terminal having dimensions of 15 inches or more. Currently, many small screen devices such as mobile devices including cell phones, personal digital assistant (PDA)s, etc. now have Internet access. However, most Web sites as they currently exist are formatted only for large format personal computer (“PC”) browsers. The wealth of information that is readily available on large format PCs is therefore not currently accessible to mobile users.

Small screen devices typically have small displays, for example 6 lines by 20 characters. The small displays limit the amount of information that can be presented at one time. In addition, small screen devices have limited bandwidth, generally less than 9600 baud. Transmissions must be kept to a minimum number of characters. The data buffer size of the small screen devices is typically limited to some small multiple of the number of characters that appear on the screen. Thus, most Web documents are too large to be downloaded to small screen devices.

Another problem encountered by small screen devices is that there is no standard markup language used by these devices. Japanese devices use a markup language that is incompatible with the full HTML used on the WWW. For example, the J-Phone Corporation of Japan uses Mobile Markup Language (“MML”). The NTT (Nippon Telephone and Telegraph) DoCoMo uses Compact HTML (“CHTML”), and DDI, IDO and Tu-Ka Corporations of Japan use Hand-held Device Markup Language (“HDML”). Most European and American devices use a markup language that is incompatible with HTML called Wireless Application Protocol/Wireless Markup Language (“WAP/WML”) or HDML.

The different markup languages limit Internet access. Web sites that are accessible to small screen devices must be compatible with the particular markup language used by the devices. One prior art attempt to provide compatible sites requires human specialists to manually create and update web-sites for small screen mobile Internet devices. For example, in Japan there are a small number of i-mode-only sites for the NTT DoCoMo cell phones. The number of i-mode sites numbers in the thousands rather than the millions of sites available on the Internet as a whole. The sites are independently developed by hand and presented as i-mode-only content. For U.S. or European phones, there is a number of WML wireless Web sites, although again the content is limited and hand generated. To make an HTML Web site accessible to different types of mobile Internet devices therefore requires separate teams to create and maintain content essentially similar to the master web page but in the different markup languages.

Palm Pilot devices use a technique called “Web clipping” to provide compatible Web content. In this technique, content, such as forms, is removed if not deemed appropriate for a mobile device. There are many Web clipping applications that permit access to specific information or Web sites on the Internet. However, this method is disadvantageous not only because displayed content is limited, but because the determination of which content is appropriate for clipping can result in data of interest to the user being deleted from the Web site.

The Xift Corporation offers a précis engine for WML devices. This précis engine is used to summarize contents of a Web site for display on a mobile Internet device. However, the Xift précis engine handles only the English language and WML markup language. Oracle's Portal-to-Go provides content to mobile devices, but it is a toolkit for software developers to connect database driven Web pages to mobile devices using a particular markup language.

Pixo Corporation produces an in-phone micro browser that is located at the client that handles both HTML and WML. This micro-browser downloads large amounts of data from a Web site. The micro browser cannot use most of this downloaded data. The micro browser located at the client causes slow and bulky data transmission. Moreover, each user would have to purchase a special mobile device having the in-phone micro browser in order to take advantage of this system.

To summarize, there are many issues and problems that have kept the Internet from being completely accessible and usable by mobile subscribers. Although many technologies exist today that enable mobile subscribers to send and receive messages, access e-mail and browse the World Wide Web, these technologies have been slow to be adopted. Mobile Internet usage is growing, but not at the rate expected by service providers, or projected by industry pundits.

It would therefore be an advantage to provide a method and system having broad technology capabilities, address a focused market, provide compelling value-added applications and, most importantly, provide an excellent end-user experience. In addition, it would be an advantage to provide a method and system allowing subscriber access to any and all Internet content and messaging regardless of what technologies are used.

### SUMMARY OF THE INVENTION

A method and system are provided for presenting data in multiple formats in a subscriber network. A request is received from a small screen device for data over a first network using a first communication protocol. The request is translated from the first communication protocol to a second communication protocol. The request is then forwarded to a sever having the requested data using the second communication protocol. The requested data is received from the sever using the second communication protocol, wherein the requested data is in a first presentation format. The requested data is reformatted in a second presentation format different from the first presentation format.

### BRIEF DESCRIPTION OF THE DRAWINGS

The accompanying drawings, which are incorporated in and form part of the specification, illustrate embodiments of the invention and, together with the description, serve to explain the principles of the invention.

FIG. 1 is a high level architectural view of a Web connection between a client system and a server system.

FIG. 2 is a block diagram of the system for customized reformatting of data according to the present invention.

FIG. 3 is a system flow chart of the system for customized reformatting of data according to the present invention.

FIG. 4 is a block diagram of the reformatting processor according to one embodiment of the present invention.

FIG. 5 is a block diagram of the Universal Bit Broker system according to one embodiment of the present invention.

### DETAILED DESCRIPTION OF THE INVENTION

A method and system are provided for presenting data in multiple formats in a subscriber network. A request is received from a small screen device for data over a first network using a first communication protocol. The request is translated from the first communication protocol to a second communication protocol. The request is then forwarded to a sever having the requested data using the second communication protocol.

The requested data is received from the sever using the second communication protocol, wherein the requested data is in a first presentation format. The requested data is reformatted in a second presentation format different from the first presentation format. A description of automatic reformatting of data for display on small screen devices is first described followed by a description of the Universal Bit Broker system.

In the following description, for purposes of explanation, numerous specific details are set forth in order to provide an understanding of the present invention. It will be evident, however, to those of ordinary skill in the art that the present invention can be practiced without the specific details. In other instances, well-known structures and devices are shown in block diagram form to facilitate explanation. The description of preferred embodiments is not intended to limit the scope of the claims appended hereto.

For purposes of description, the term “small screen display devices” will be used to refer to an electronic device having a small display screen and in communication with an electronic network, including but not limited to the Internet. However, the teachings herein can be applied to any appropriate small display screen device, including mobile Internet devices and devices that are not mobile, such as an Internet-capable phone. The use of the term small screen display device is therefore for descriptive purposes only and is not intended in any way to limit the scope of the invention as claimed herein.

One skilled in the art using well-known hardware components can implement any or all of the hardware configurations of the present invention. In the presently preferred embodiment, the present invention is implemented using at least one computer. Such computer can include but is not limited to a personal computer, network computer, network server computer, dumb terminal, personal digital assistant, work station, minicomputer, a mobile Internet device such as a cell phone, and a mainframe computer, as well as one or more computers that are linked together in a network such as a local area network, or wide area network. For example, the identification, reformatting, parsing and/or processing features of the present invention can be implemented as one or more software applications, software modules, firmware such as a programmable ROM or EEPROM, hardware such as an application-specific integrated circuit (“ASIC”), or any combination of the above.

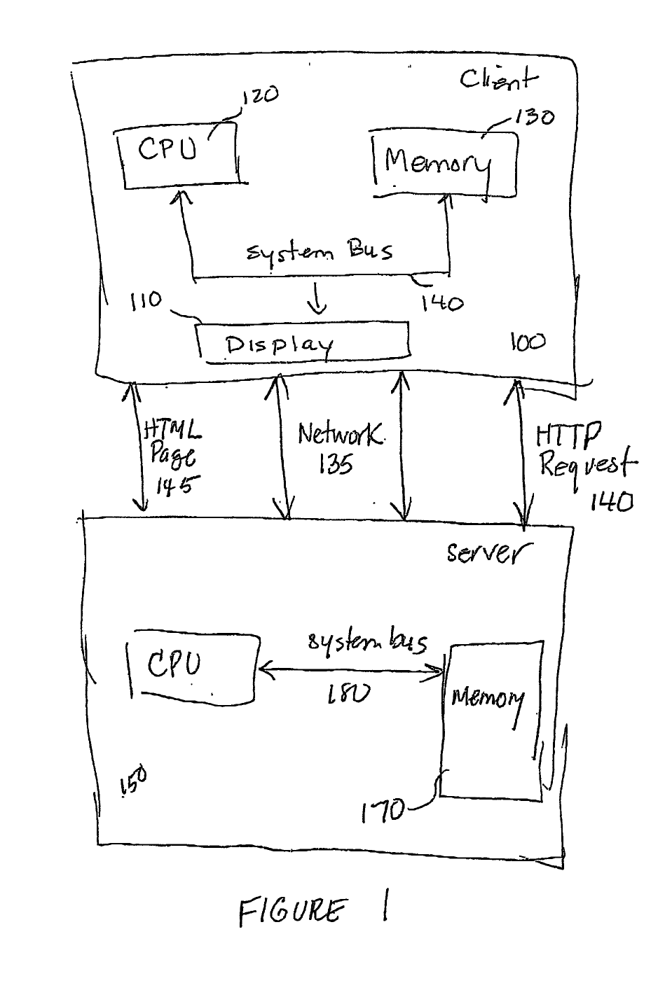

Reference is made to FIG. 1 illustrating a high level architectural view of a Web connection between a client system and a server system. In FIG. 1, a client system 100 consists of a Central Processing Unit (CPU) 120, a memory 130, and a display 110 which are connected together by a system bus 140. Memory 130 stores browser software to communicate with server system 150. It will be understood by a person of ordinary skill in the art that client system 100 can also include other elements not shown in FIG. 1 such as disk drives, a keyboard, etc. Server system 150, on the other hand, includes a CPU 160 and a memory 170 which are connected together by a system bus 180. Memory 170 stores HTTP server software and may also store a set of programs implemented in accordance to one embodiment of the present invention. A person of ordinary skill in the art will understand that memories 130 and 170 may also contain additional information such as application programs, network communication programs (e.g., TCP/IP protocol), operating system software, data, etc. Client system 100 and server system 150 are linked together by a network 135.

In an exemplary exchange, an end-user uses client system 100 to execute a browser program stored in memory 130 to request, retrieve, and display network documents such as Web pages. Each request by client system 100 for retrieval of a network document is formulated in accordance with the network protocol (e.g., HTTP) and transmitted across network 135 to server system 150. Server system 150 receives HTTP requests such as request 140 and processes them using the HTTP server software (e.g., standard network server software) stored in memory 170. The HTTP server software of server system 150 then instructs CPU 160 to retrieve HTML Web page 145 from data stored in memory 170 and to transmit a copy of HTML Web page 145 back to client system 100 for display on display 110.

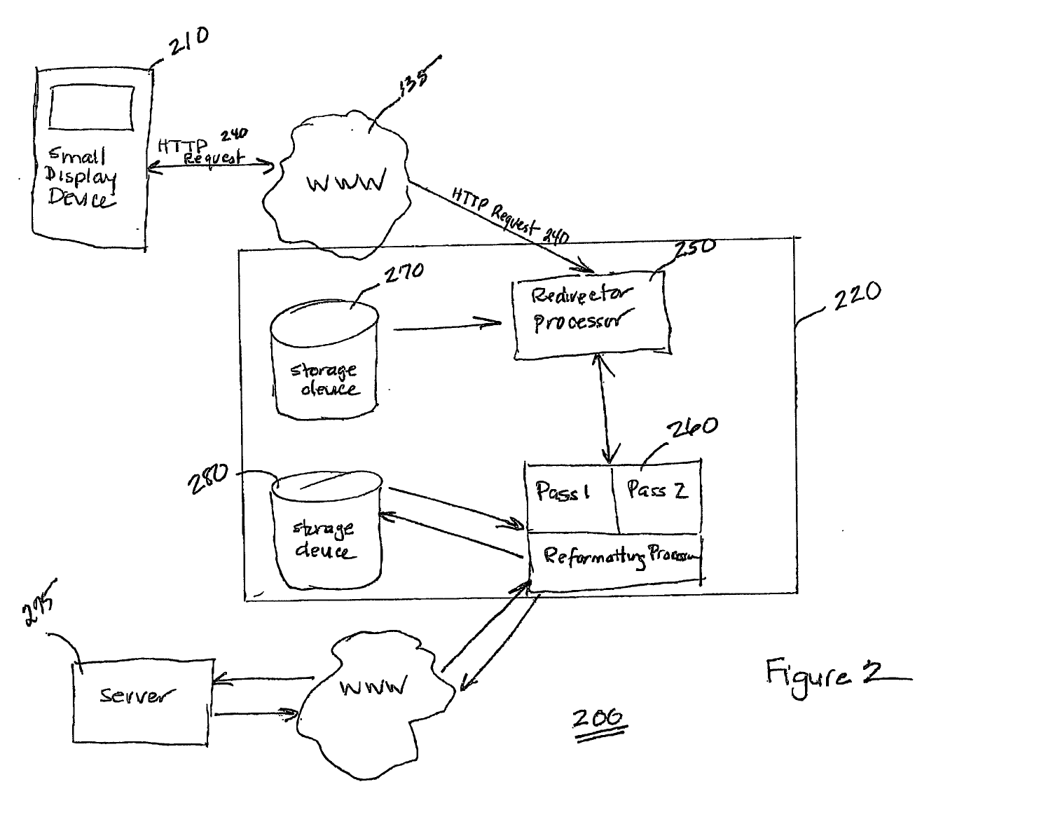

FIG. 2 is a block diagram of a system 200 for customizing the presentation of data according to one embodiment of the present invention. As shown in FIG. 2, client system 210 which is an Internet-enabled device such as a small screen display device accesses system 200 according to the present invention through an electronic network such as the World Wide Web (“Web”) 135 by sending HTTP request 240 containing a Universal Resource Locator (“URL”) request to a Web server 220. Web server 220 includes a redirector processor 250, storage devices 270 and 280 and reformatting processor 260. The system according to one preferred embodiment of the present invention includes at least one, and preferably a plurality of interpretive language software programs used for active Web documents. Popular interpretive language software programs include JAVA SERVLET, JAVABEAN and JAVA SERVER PAGE (JSP) (“JAVA SERVLET”, “JAVABEAN” and “JAVA SERVER PAGE” are all trademarks of Sun Microsystems, Inc.). In one preferred embodiment of the present invention, the JSP functions as a redirector processor or alternatively multiple servers can be used, as will be described in further detail. One of skill in the art will recognize that the invention can alternatively be implemented in other well-known programming languages. In one preferred embodiment of the present invention, when a request for a particular Web site is made, the system initially reformats the data into data written an intermediate markup language data during a first pass. On a second pass, the data is further processed according to a specific rule set for the corresponding mobile device and sent to the requesting mobile device.

The HTTP request 240 sent by the client device 210 includes a user-agent header. The user-agent header includes a unique device signature assigned to client device 210. In general, every device, connected to the Internet is assigned a unique device signature by the manufacturer. HTTP designates a user and agent header (user_agent:<string>) which based on information the system selects a rule set and determines which rule to apply.

An identifier entry is stored in database 270 which represents the device signature for each client device connected to the Internet. The identifier entry is a character string that is used to determine the device accessing the invention from the user agent field in the HTTP header.

According to one embodiment of the present invention, device characteristics are also stored in database 270. Database 270 may be located separate and remote from other system components such as the redirector processor or the reformatting processor. However, in alternative embodiments, the device characteristics can be stored as a part of the reformatting processor. In a preferred embodiment of the present invention, each client device connected to the system has a separate entry and name in database 270. Additional entries in database 270 give formatting hints for the reformatting processor, including but not limited to the screen height and width for pagination, whether the device can handle images, and whether the client device can support color or black and white. The signature is thus used to find the client device's identification information, including but not limited to model, screen dimensions and characteristics such as color capabilities and graphics capabilities. The signature is also used to find a rule set that will be used in processing the requested markup language (“ML”) data. The ML used by the device is stored in database 270, so once the signature is known, then the ML it uses is also known.

Redirector processor 250 redirects HTTP request 240 from client device 210 to database 270 to retrieve the ML and the device characteristics. The redirector processor 250 then sends back to the requesting client device 210 the identification information as well as a text input area for receiving the URL to be processed by the redirector processor 250. In other embodiments of the present invention in which the URL is fixed and known, the identification information as well as a text input area for receiving the URL is not returned to the client device 210, and the redirector processor 250 begins processing immediately.

Because the rule set for the requesting client device 210 is known, the redirector processor 250 sends the user a request asking for the Web site the user desires. The user of the client device 210 enters the URL to be visited. The URL of the requested Web page, the device characteristics, and any additional information are sent to the reformatting processor 260 for processing. The reformatting processor 260 communicates with storage device 280 which has stored therein other processing information.

The system then sends the URL to the remote Web server 275 for the Web site represented by the URL and requests that ML source data from the selected Web site be returned to the reformatting processor 260. This step is accomplished in a two-pass operation where the first pass includes storing the ML source data in an intermediate markup language while the second pass includes converting the stored data into data written in a markup language designated by the client device 210. This intermediate markup language is called Interlingua. The reformatting processor 260 receives the ML source data from the remote Web Server 275. If the requesting client device 210 is capable of displaying a large screen format browser, the reformatting processor 260 sends the ML source data to the redirector processor 250 which, in turn, forwards the ML source data to client device 210, with no further intervention by the reformatting processor 260. Otherwise, the reformatting processor 260 reformats the ML source data in accordance with the rule set that has previously been selected for the format used by the identified requesting client device 210 stored in storage device 280. The reformatting processor 260 then sends the reformatted ML source data to the redirector processor 250 and finally through the network 135 back to the requesting client device 210.

The software applications that are used with the present invention can be stored on any storage device accessible to the computer(s) of the system, including but not limited to a hard drive, CD-ROM, DVD, magnetic tape, optical drive, programmable memory device, and Flash RAM. It will be readily apparent to one of skill in the art that the software applications can be stored on the same or different storage devices.

The reformatting processor 260 is a tag-by-tag ML rewriting processor that applies external rule sets to ML source data. In accordance to one embodiment of the present invention, the reformatting processor 260 handles multiple rule sets simultaneously, applying the particular rule set as required by the requesting client device 210. The rule sets are preferably stored externally to the reformatting processor 260 and are interpreted dynamically. Alternatively, the rule sets can be stored as a part of the reformatting processor 260. Rule classes preferably capture entire families of devices (e.g. WML-class, CHTML-class). The rules that are included in these rule sets encapsulate a rewriting language that can be used, for example to rewrite HTML into WML while preserving the formatting of forms. Rule sets can also be specialized for a particular device. A device can use a rule class as well as specific rules in the device's rule set. The generic rules are augmented by the specific rules.

Because Web sites typically have more variability in styles than small screen display devices, the preferred embodiment of the invention uses Web site-specific rules as well as format-specific rules. Web site rules are always applied before format-specific rules. Web site-specific rules can be designed, for example, to enhance the particular Web site experience, or to provide customization to maintain a particular look and feel. As an example, a Web site formatted for the PC frequently has a series of navigation links at the top of the screen. When a Web site is reformatted for a small screen device, it can be advantageous to move these navigation links to the bottom of the screen, so that the actual content appears first. The invention is not limited to this example, but rather provides a method whereby such examples may be implemented.

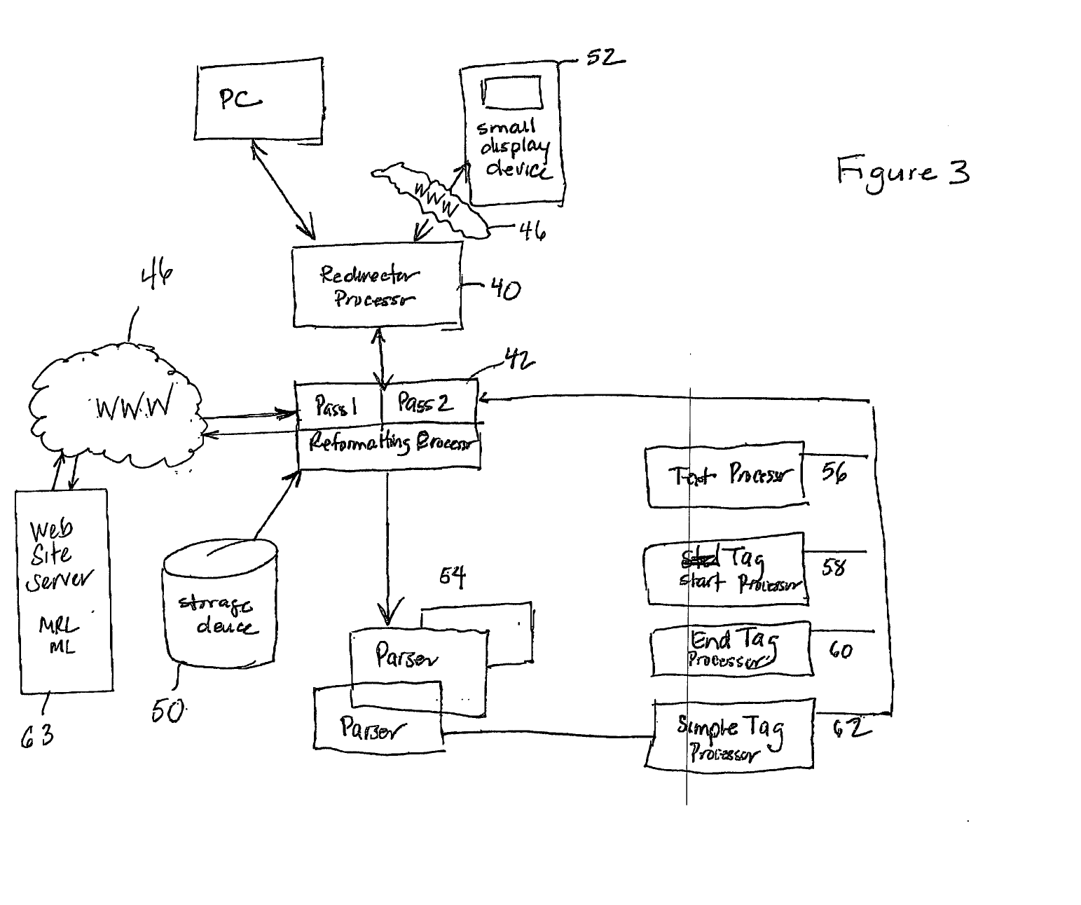

FIG. 3 is a system flow chart of the system for customized reformatting of data according to the present invention. A redirector processor 40 receives, from a mobile Internet device 52, a Universal Resource Locator 44 indicating a Web page to be reformatted for display on the requesting device 52. A redirector processor 40 checks the requesting mobile Internet device's identification information and sends the identification information and the URL to a reformatting processor 42. The reformatting processor 42 reads in the ML reformatting rules 50 associated with the requesting device 52 and passes these rules to a ML parser processors 54.

The reformatting processor 42 communicates with Web site server 63. The reformatting processor 42 sends the URL identified therein, requesting that ML source data be returned to the reformatting processor 42. In response to this request, the requested ML source data is returned from the Web site server 63 via network 46 to the reformatting processor 42 and then sent to the ML parser processors 54. The ML parser processor 54 processes the ML source data from the Web site and calls associated processors 56, 58, 60, 62 depending on the tag type for further processing. ML tags identifying formatting options are classified into 4 types: plain text 56, start tag 58, end tag 60, and simple tag 62. Each of the processors then processes the data embedded in each respective tag type, applying the reformatting rules to each tag as it is read. The rule associated with each tag is applied and the result is reformatted as an intermediate ML. The intermediate ML is reformatted via reformatting processor 42 into device specific ML that was identified by the mobile Internet device 52 and the reformatted data is sent for display on the mobile Internet device 52. For example, if the user has an i-mode phone and wants to view a WAP site, the system would retrieve the WAP ML site data from a remote server and then as an intermediate step compress, reformat and store the data in a cache. Since the requesting device is an i-mode device, the ML would parse the data once more into CMTL for i-mode display. Assuming this step has taken place (the storage of data from a WAP site), an identical request for the same Web site can be made from a J-Phone device. Rather than retrieve the data from a remote server having the desired Web site data as before, the system would query its cache to determine if the requested data is stored therein. If the data has been stored in the cache, the system retrieves the stored data that has been compressed and reformatted in the intermediate ML. The system would then merely apply the J-phone's rule set for displaying the data on its small screen. Having the data stored in the system's cache saves an entire processing step because the system does not have to retrieve the data from a remote Web server.

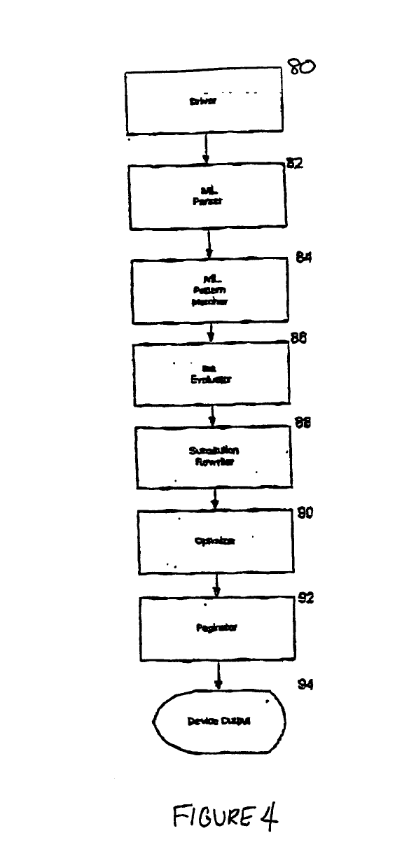

FIG. 4 is a block diagram of the reformatting processor according to the preferred embodiment of the invention. The components of the reformatting processor include:

a driver 80;

a ML parser 82;

a ML tag pattern matcher 84;

a rule evaluator 86;

a substitution rewriter 88;

an optimizer 90; and

a paginator 92.

Driver

The driver 80 establishes a connection to the Web site represented by the requested URL, and opens a connection to retrieve the requested ML source data from the Web site. The driver locates the rule set that is to be used with the requesting device, and passes this information on to the markup language parser. The ML parser reads the stream from the site and identifies the specific tags for processing. The ML parser reads byte streams from the designated site and breaks up the bytes that can be interpreted by the reformatter. Different ML parsers are required for different sites. For instance, bytes will represent different tags based on the ML deployed by the carrier and the carrier's peculiar specifications. Consequently ML parsers are specialized to each markup language and then specialized further to the particular carrier.

ML Parser

Control is then passed to the ML parser 82, which breaks the ML source data into the constituent elements referred to herein as the , namely: for each of the start tag, the end tag, the simple tag and the text element. These four constituent elements comprise the content of MLs processed by the system

ML Tag Pattern Matcher

Each tag from the ML source data is passed to the ML tag pattern matcher 84. The ML tag pattern matcher uses a pattern-matching algorithm to match rules by sequentially testing each rule, for example, starting from rule 1, until a match is found. The tag pattern matcher commits to the first matching rule, if any, and the pattern-matching process is terminated. The matching process is described herein, below. Rule heads, defined for purposes herein as all text to the left of the symbol “−>” in a rule, can contain variables or sequences of variables which match and bind with the incoming ML, as will be described herein in more detail, below.

In the preferred embodiment of the present invention, rules are expressed as text in a computer language, called the Mobile Rule Language (MRL). While the invention is described herein with respect to the preferred MRL, one of skill in the art will recognize that, in alternative embodiments, other suitable computer languages can be used. In the preferred embodiment of the present invention, rules written in the MRL are of the form:

rule head −> rule body

The “head” or “rule head”, which comprises all characters to the left of the symbol “−>”, is matched against the incoming ML through pattern matching substitutions. The “body” or “rule body” of the rule comprises all characters to the right of the “−>” symbol.

For example, in the rule:

<HTML>−>wml>

the <HTML> tag is replaced with a <wml> tag. Tag attributes can be matched through patterns. A tag attribute is a series of letters followed by an “=” sign, followed by any characters, with the exception of the “>” character. The ML tag pattern matcher identifies a pattern by starting with the “@” sign (which is optionally followed by at least one other “@” sign), followed by a number that uniquely identifies that matched pattern.

For example, in the rule:

<img src=@1 alt=@2>−>@2

the img tag “alt attribute value”, (the value to the right of the “=” sign), is assigned to the pattern match uniquely identified by the symbols “@2”. The rule body replacement value is identified as “@2” ( the symbols to the right of the “−>” symbol).

For example, when matched against HTML, input source such as:

<img src=mypic.jpg alt=“My picture”>

matches the rule:

<img (? src=@1alt=@2?)>−>@2

with the result that the variable @1 would be bound to “mypicjpg” and the variable @2 bound to “My picture”. Thus, the text “My picture”, which is the rule body, replaces the HTML input source.

In the presently preferred embodiment, pattern variables of the form:

@<small integer>

bind once within a rule and have scope only within that rule. Once bound, these variables are not rebound. As has been discussed previously, once one rule head is matched, there is no attempt to locate another matching rule. Another variable that can be used in rules is the anonymous variable @, which matches any of number of times within the rule, but whose binding value is not available. Yet another such variable is @@, which is anonymous and matches any text. The anonymous variable @ is used if the value bound is not required. The variable @@ is used to discard input or to match any unknown number of attributes whose names and values will not be used. Additionally, the construct (? . . . ?) is the alternating construct that allows the attribute/value pairs contained therewithin to be matched in any order.

Rule Evaluator

When a match for the rule head is found, all variables, for example “@1”, “@2”, are bound as has been previously described. The right hand side portion of the rule, the rule body, is then executed by the rule evaluator 86. The rule evaluator is a stack-based interpreter that can perform conditional evaluation and simple counting/logic functions. The interpreter for the MRL can be written in any computer language, however, the preferred embodiment is written in Java. The evaluator is a stack-based interpreter.

Operators of the MRL can include well-known arithmetic and Boolean operators such as the addition operator, expressed in the MRL as the symbol “+”. The entire set of operators will be detailed in Tables 1, 2, and 3. In the preferred embodiment, strings are character sequences that can be in three forms:

1. ‘any characters’

2. “any characters”

3. <any characters>

The first form is a constant string in which variables within the string are not evaluated. In the second string form, variables within the string are evaluated. In the third form, variables within the string are also evaluated but the delimiters <and > are retained after evaluation.

For example, assuming the variable @2 is bound in the rule head to myPicjpg, the value of:

‘@2’ is @2

The value of:

“@2” is myPicjpg

Assuming the variable @2 is bound to http://www.sun.com, the value of:

<a href=@2> is <a href=http://www.sun.com>

Substitution Rewriter

After a match is made for the head of the rule has been determined, the MRL evaluator generates a string result by evaluating the rule body. The substitution rewriter 88 is then used to replace the original ML. As each tag is read, the rewritten HTML is accumulated by the reformatting processor. When the entire web page has been processed, the accumulated rewritten ML is passed on to the Optimizer 90.

The right hand side of a rule can contain expressions such as conditional constructs. A conditional construct is one that is executed by the interpreter conditionally, depending on the truth value of the expression to the left of a conditional operator. In the presently preferred embodiment, the conditional operators are represented by the symbols “?” and “??”. A list of language constructs according to the preferred embodiment of the invention is shown in tables 1, 2, and 3. For explanatory purposes only, the following examples show relevant constructs according to the invention.

Mobile Rule Language Construct Summary

The Mobile Rule Language (MRL) is a simple stack-based language with variables, conditional constructs and some numeric and string manipulation capability. Language entities are:

TABLE 1
OPERATORS

| Operator | Precedence | Value |
|---|---|---|
| <expr1>??<result> | 3 | if <expr> is true return <result> else null |
| <expr>?<result1>:<result2> | 3 | if <expr> is true return <result1> else return |
| | | <result2> |
| <expr1>==<expr2> | 5 | return false if <expr1> equals <expr2> else |
| | | true |
| <expr1>!=<expr2> | 5 | |
| !<expr> | 9 | return false if <expr> is true else true |
| <expr> ; <expr> | 2 | go on to next expr, leaving result on stack |
| @<name>=<expr> | 7 | Assign value of <expr> to variable |
| | | @<name> |
| @<name>++ | 9 | Increment value of variable leaving prior |
| | | value on stack |
| <string> + <string> | 4 | Concatenate strings |
| <string> \hat{ } <string> | 4 | Concatenate strings merging absolute URLs |
| <number> + <number> | 4 | Add numeric values, leave result on stack |
| <number> − <number> | 4 | Subtract numeric values, result on stack |
| <number> * <number> | 5 | Multiply numeric value, result on stack |
| <number> / <number> | 5 | Divide numeric values, result on stack |
| <expr1> >= <expr2> | 3 | return true if <expr1> is numerically greater |
| | | than or equals <expr2> else false |
| <expr1> <= <expr2> | 3 | return true if <expr1> is numerically less |
| | | than or equals <expr2> else false |
| <expr1> > <expr2> | 3 | return true if <expr1> is numerically greater |
| | | than <expr2> else false |
| <expr1> < <expr2> | 3 | return true if <expr1> is numerically less |
| | | than <expr2> else false |

TABLE 2
VARIABLES

| Variable | Explanation |
|---|---|
| @ | Anonymous variable matching one attribute or value |
| @@ | Anonymous variable matching any number of attribute/value pairs |
| @<small int> | Pattern variable scoped to single rule |
| @<name> | Named variable scoped to entire page |
| (? ?) | Alternating match, enclosed attribute/value pairs matched in any order |

TABLE 3
CONSTANTS

| Value | Explanation |
|---|---|
| true, false | Boolean constants |
| 0, 1, . . . 9* | Numeric decimal constants |
| name(arg[, arg]*) | Function call |
| ‘character*’ | Non evaluating string |
| “character*” | Evaluate-in string |
| <character*> | Evaluate-in string |

Optimizer

An optimizer 90 is used to parse the resultant output ML and optimize it to minimize the size of its useful content. The optimizer removes extraneous content which is not useful and which slows the content download time to the device. The optimizer does not, however, remove viewable content. The output rewritten ML is preferably optimized in two passes, removing empty elements that may have been created by rule application. However, in alternative embodiments, any appropriate number of optimizing passes can be used. Examples of such empty elements include <BR><BR> sequences, empty paragraphs <P></P> and empty font changes <FONT></FONT>. The optimized result is a very compact file that can be sent to the device at very high-speeds because of its small size. In the preferred embodiment, a copy of the optimized result can also be stored in one or more cache memories. In this embodiment, when a device of the same type accesses the same URL this optimized output can be retrieved directly from the cache.

Paginator

The paginator 92 breaks the optimized result into a series of pages that fit the screen size of the requesting device. Page forward, home and page back links are added to the bottom of the screen. The current page number and last page number are also added. The requested Web page is than sent out to the device in a short burst of text or compiled device markup language.

Example 1 illustrates exemplary identifier and formatting entries according to the preferred embodiment of the invention.

### EXAMPLE 1

// Devices
//
// Add a phone or device by giving it a unique entry as below,
// serially to the end of the list.
//

| | |
|---|---|
| // system.phone.name | is a unique arbitrary name for the device |
| // system.<name>.identifier | the identification signature passed in |
| // | the http User-Agent field |
| // system.<name>.width | the screen width in characters |
| // system.<name>.height | the screen height in characters |
| // system.<name>.color | true if the device supports color, |
| // | else false |
| // system.<name>.images | true if the device supports gif images, |
| // | else false |
| // system.<name>.description | a brief description of the device |
| // | |

Sites are also identified in the system properties file 22 for determining site rules.

Exemplary entries in the properties file can be used to:

add a site by giving it a unique identifier;

add it serially to end of list; and

add the site URL to identify the site.

The sites that have specific site rules are identified and the URL is used as a signature. Each device and site that is named in the system property file has a property file of the form:

System.<name>properties, where <name> is the device name or the site name.

Example 2 illustrates site rewriting rules according to the preferred embodiment of the invention. The Example shows exemplary site rules for the TEST1 site. This site has a frame front page. The processing of HTML is simply redirected to the content frame whose name is “TEST2”, by following the second frame link.

### EXAMPLE 2

system.rule.TEST1.1=<FRAME (?SRC=@2 NAME=@3?)>−>(@3==“TEST2”)??

@location=MyURL^{Λ}@2”

system.rule.TEST1.2=</@@>−></@1>

system.rule.TEST1.3=<@@>−><@1>

Example 3 illustrates the use of rule classes. In this Example, the only rule needed to capture the device capabilities is the CHTML version 2.0 rules. Devices can explicitly list all rules, list specific rules and then reference rule classes, or may simply reference rule classes. This Example provides exemplary device rewriting rules according to the CHTML version 2.0 rule class:

### EXAMPLE 3

system.rule.CHTML20.1=<HTML version=@1>−><HTML>

system.rule.CHTML20.2=<HEAD>−><HEAD><META HTTP-EQUIV=“content-type”

CONTENT=“text/HTML; charset=x-sjis”> . . .

system.rule.CHTML20.12=<MARQUEE (?behavior=@2 direction=@3 loop=@4 ?)>−>

(@4>16)?<MARQUEE behavior=@2 direction=@3 loop=16>:<MARQUEE

behavior=@2 direction—@3 loop=@4> . . .

system.rule.CHTML20.107=<AREA (?alt=2 href=@3?)>−>(@3!=′′)?<BR><A

HREF=@BASEURL@MyURL^{Λ}@3>@2</A>:@2

system.rule.CHTML20.112=<OPTION (? VALUE=@2?)>−><BR><A

href=@,BASEURL@MyURL^{Λ}@2 ACCESSKEY=@n>;@n++

system.rule.CHTML20.113=<OPTION>−><BR>

system.rule.CHTML20.114=</OPTION>−></a>

system.rule.CHTML20.115=<FRAMESET@@>−><HR><CENTER><FONT

COLOR=MAROON>Menu</FONT></CENTER><HR><OL>

system.rule.CHTML20.116=</FRAMESET>−></OL><HR>

system.rule.CHTML20.117=<FRAME (?SRC=@2 NAME=@3?)>−><LI><A

href=@BASEURL@MyURL^{Λ}@2>@3</A>

system.rule.CHTML20.118=<NOFRAMES>−>

system.rule.CHTML20.119=</NOFRAMES>−> . . .

system.rule.CHTML20.134=</@@>−></I@1>

system.rule.CHTML20.135=<@@>−><@1>

The last two exemplary rules of Example 3 are “catch-all” rules that pass though any tag, untouched.

In general, the present invention discloses a method and system for customizing the presentation of Web site data for display on small screen display devices, such as mobile Internet devices. The user of the small screen display device sends a HTTP request to a first World Wide Web server site implementing the system according to the present invention. This HTTP request is transmitted to a redirector processor. The redirector processor determines the signature of the requesting device and is thereby able to identify device characteristics, such as the type of markup language used by the device, as well as the device's screen dimensions, graphics capabilities, and graphical characteristics. A rule set for use in processing data requested by the requesting device is thereby determined. In addition, stored customized reformatting parameters are also retrieved for processing data.

In an alternative embodiment, the redirector processor transmits back to the requesting device a text input area in the markup language used by the device. The user can then enter into this text input area a URL representing a Web site that the user wishes to access. The request for access to the site represented by the URL as well as the identified device characteristics information is transmitted to a reformatting processor. The reformatting processor sends a request for data to the remote Web server for the Web site represented by the URL.

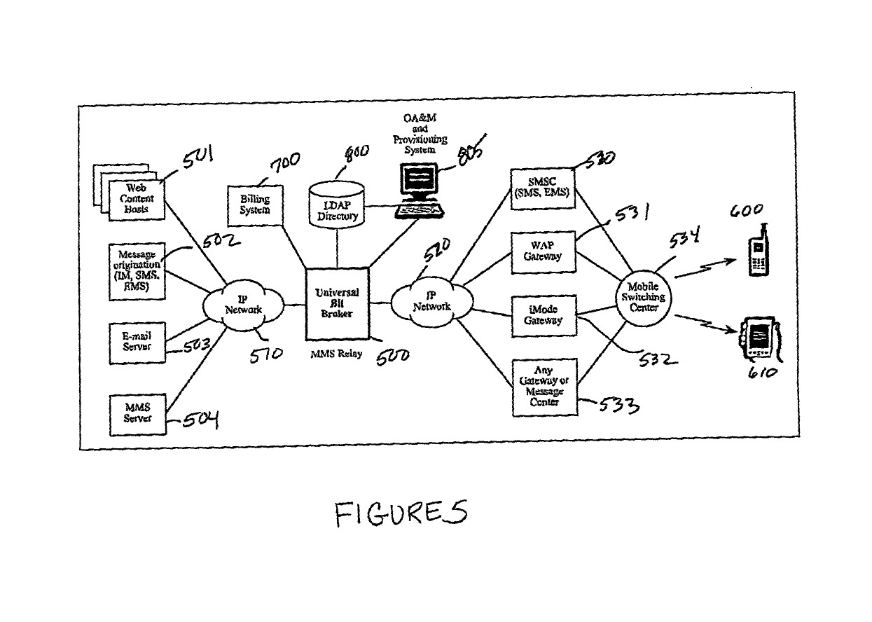

FIG. 5 is a block diagram of the Universal Bit Broker system according to one embodiment of the present invention. As shown, the system includes Universal Bit Broker 500 in communication with billing system 700, database 800 and a host of servers and gateways via IP networks 510 and 520. The host of severs includes, but are not limited to, Web content host 501, Message server 502, email server 503 and multimedia message server 504. Web content host 501 transmits data using HTTP. Message server 502 transmits data using multiple messaging standards such as instant messaging (IM), short message service (SMS) and enhanced message service (EMS). Email server 503 transmits data using simple mail transfer protocol (SMTP) and multimedia message server 504 transmits data using multimedia message services (MMS).

According to one embodiment of the present invention, these protocols and services are stored in database 800 for retrieval by Universal Bit Broker 500. Also stored in database 800 is mobile rule language (MRL) software which is used in reconfiguring data in one markup language to data in another markup language. The gateways include SMS, SMSC and EMS gateways 530, wireless application protocol (WAP) gateway 531, iMode gateway 532 and any other gateway or message center 533. These gateways communicate with handheld devices 600 and 610 via mobile switching center 534. According to one embodiment the present invention, to allow handheld device 600 and 610 to properly communicate with the various host servers 500 and receive data in the proper format, Universal Bit Broker, Universal Bit Broker 500 includes Mobile Rules Language (MRL) software that enables reformatting and translation of data in one presentation format to data in another format. According to one embodiment of the present invention, Universal Bit Broker 500 also communicates with database 800 determines whether a subscriber using handheld devices 600 or 610 is a subscriber to the system.

Accordingly, a user of handheld device 600 seeks to retrieve data from one of the various host servers 501-504. The user communicates over a first network such as mobile switching center network 534 using a first communication protocol such as the Hand Device Transfer Protocol (HDTP). Universal Bit Broker 500 receives the request from the user via gateways 530-533. Universal Bit Broker 500, if needed, translates the request from the first communication protocol to a second communication protocol such that the host server having the requested data can communicate with the Universal Bit Broker. The Universal Bit Broker transmits the request to the host server having the requested data using the second communication protocol such as HTTP over a second network such as the Internet. The host server sends the requested data to the Universal Bit Broker 500. The requested data is in a first presentation format. The Universal Bit Broker, if needed, reformats the requested data in a second presentation format according to a specific set of markup rules. According to one embodiment of the present invention, the user may be registered for presentation of data in the format that is provided by the host server supplying the data. If so, the user is not charged for the presentation of data from one format to the format that the user desires to be displayed on his handheld device. Alternatively, if the user is not a subscriber to the system, the user is charged for the reformatting of data from one format to the format the user desires. The following is a brief description of the advantages the Universal Bit Broker can provide.

Internet access via wireline connected computers is becoming more and more ubiquitous everyday. The challenge is to bring this Internet access to mobile subscribers via wireless devices that is user-friendly and provides the applications, content and messaging that they desire. The market for these advanced mobile services is no longer limited to high-end business users; rather, as the Internet has brought more applications and services to the general public, pedestrian users desire mobile access. The market has changed and it is anticipated that someday all mobile telephony subscribers will desire full access to the Internet and the services it can provide. The traditional wireless business model of starting with business customers and eventually working down to the mass-market is no longer valid. Today, all services must start with the mass market. “Walled gardens” of content will not survive and successful mobile Internet access requires much richer messaging applications and content from any source. The mobile Internet is a different environment than the Internet accessed by fixed wireline computers. Mobile Internet access is not simply an extension of the wireline-accessed Internet today. Mobile access defines a different paradigm for Internet usage that requires new classes of applications and services that are specifically developed for this new type of use. The promise of the mobile Internet is that an application can be served to users such that the network and wireless device account for certain device limitations and differences among those devices. Also, the behavior of mobile users is different from the behavior of traditional desktop Internet users and these differences must be considered when service providers offer the mobile Internet to subscribers. Many of these differences relate to subscriber and device preferences, which directly relates to user-friendliness, ease of use and the ability to fulfill the expectations of subscribers. Small wireless devices, with a variety of small screen sizes and capabilities, along with mobility, dramatically change subscribers' usage patterns.

The Universal Bit Broker product can be divided into three functional areas:

1. Universal Bit Broker software infrastructure

2. Subscriber-customized website views (including custom home page creation)

3. Content provider-customized website views

The present invention's unique competitive advantages lie within the following features and functions:

The Mobile Rules Language (MRL) enabling rule sets to be easily defined by end-users and content providers and modified to customize the translation of messaging and web content for presentation on any mobile Internet device.

Customized website views enabling end-users (subscribers) to easily customize the presentation of any web page on their mobile Internet devices.

Customized website views enabling content providers to easily customize the presentation of any web page accessed by all subscribers for all mobile Internet devices.

Messaging support enabling end-users (subscribers) to send and receive personal messages that include media-rich content across multiple messaging standards (i.e., IM, SMS, EMS and MMS).

End-user control enabling subscribers to directly and easily add, modify and delete content on personal web pages, send personal web pages to other subscribers and receive personal web pages from other subscribers.

The Universal Bit Broker is a software infrastructure product designed to enable universal access to any and all Internet content and messaging from any device. The Universal Bit Broker software infrastructure technology is designed to provide the following mobile Internet solutions:

Provide a solution that is critical to enabling access to the mobile Internet and messaging services from any device.

Provide a solution that is highly scalable and highly reliable for carrier-scale network deployments.

Provide a solution that enables subscribers to access high-quality, media-rich content and media-rich messaging in a user-friendly way. Media-rich can be defined as text, images, audio and any combination as mixed media.

Provide a solution that is future-proof and is extensible to support any additional media-types as they become available as messaging content or web content (e.g., video streaming and audio streaming).

Provide a solution that resolves the problem of multiple and incompatible standards and solutions for messaging, e-mail, fax and web access.

Provide a solution that supports the wide variety of wireless devices and mobile phones that subscribers use. Each of these devices has varying and non-standard physical characteristics.

Provide a solution that supports any digital wireless network technology (e.g., GSM, ANSI-41, PDC, W-CDMA, CDMA2000).

Provide a solution that supports any mobile Internet transport technology (e.g., WAP, i-Mode, t-Mode, 1-mode, etc.).

Provide a solution that supports any type of client software version or technology (e.g., WAP, i-Mode, etc.)

Provide a solution that supports mobile Internet access via 2 G, 2.5 G and 3 G technologies.

The Universal Bit Broker software is a server-based enabling technology allowing subscriber access to any website—even those not designed for the service provider's chosen mobile Internet technology, that supports all messaging technologies and Internet content. It is a product designed to make a mobile Internet subscriber's experience better. That is, it is not designed to replace existing mobile Internet technology; rather, it is designed to enhance mobile Internet technology, regardless of what that technology is.

The product is a powerful and flexible content broker serving as mediation software allowing subscriber access to any and all Internet content and messaging regardless of the technologies used. The Universal Bit Broker software is designed for carrier-scale deployments, supporting mobile Internet access by subscribers of the largest service providers in the world.

The Universal Bit Broker software supports web content, messaging, e-mail and fax services to allow any subscriber to access those services regardless of the technology deployed to deliver those services. The Universal Bit Broker software provides the following features:

Open and modular standard interfaces to support messaging services, e-mail services, fax services and web content.

High scalability and high reliability platform for large tier 1 service providers in a telephony-grade environment.

A service enabling environment, allowing service providers to deploy a single solution supporting any messaging or content application to any device.

The unique Mobile Rules Language (MRL) enabling rule sets to be easily defined and modified to customize the translation of messaging and web content for presentation on any mobile Internet device.

It enables any network or service provider to offer i-Mode services regardless of the network technology deployed. Service providers partnering or planning to partner with NTT DoCoMo can offer service much more quickly and easily. It enables i-Mode sites to be offered to subscribers on any device, not just i-Mode devices i-Mode sites can be accessed by WAP-only devices and WAP sites can be accessed by i-Mode-only devices eliminating the need for multiple client software on mobile devices.

Message content translation supporting instant messaging services (IM), short message services (SMS), enhanced message services (EMS), e-mail, fax and multimedia message services (MMS). Note that for IM, the content is simply translated within the instant message format. Direct connectivity to traditional IM service providers is not required.

Image translation supporting PNG, WPNG, BMP, WBMP, GIF and JPEG.

Audio translation supporting simple audio such as ring tones and simple sounds.

Audio translation supporting AMR/EFR, WAV and MP3.

LDAP directory access supporting standard access to service providers' user profiles for mobile Internet access.

Billing system recording and access to record unique characteristics of the traffic and usage patterns of subscribers. The charging detail records (CDRs) contain unique information such as the type of content and messages, and the type of transaction occurring. This will enable service providers to bill subscribers and content providers based on these criteria and enable access to market data about their subscriber base.

Comprehensive operations, administration and maintenance interfaces enabling service providers to perform configuration management, software change control, fault management and performance management.

Provisioning interfaces enabling service providers to activate, deactivate, modify, and screen subscriber usage. Blocking of messaging and web content on a per-site, per-user and per-address basis is also provided.

In addition the Universal Bit Broker is fully compliant with the MMS Relay functions for the UMTS 3GPP standard multimedia messaging service (MMS). These functions are as follows:

Receiving/sending multimedia messages

Enabling/disabling the MMS function

Personalization based on user profile

Message deletion commands

Media type conversion

Media format conversion

Message content retrieval

Forwarding of messages

Screening of messages

Negotiation of terminal capabilities with a directory

Checking terminal availability from a directory

Message notification to user-device

Generation of charging data records (CDRs)

A unique competitive function of the Universal Bit Broker product is the ability for end-users (subscribers) to customize the presentation of website content and messages on their mobile Internet devices. Wireless service providers need solutions that allow customized configuration of the messaging and content displayed on wireless devices enabling subscribers to easily access and use content with fewer keystrokes. This function is very powerful and solves the following mobile Internet problems:

User interfaces on mobile wireless devices are typically awkward and unfriendly.

There is limited interaction among client software on the mobile devices, limiting the utility of the available content (e.g., messaging applications and browsers working together).

Website content is typically designed for desktop client browsers. Presentation of all of this content on small mobile devices can be crowded, intricate and convoluted.

Users typically need to perform many, many keystrokes through all of the web presented content to get to the content they desire.

Customized website views enable end-users (subscribers) to easily customize the presentation of any web page on their mobile Internet devices specifically for the content they commonly access. This avoids unwanted content, unnecessary keystrokes and unnecessary scrolling. These custom views may also be shared with other subscribers when sent via e-mail.

This function also enables subscribers to create custom personal home pages based upon information originally required to provision them for service. This is a powerful and compelling feature because these personal home pages can be sent and received as messages.

The subscriber-customized website view function of Universal Bit Broker software provides the following features:

Ability to customize website content presented on any mobile Internet device. End-users can use a desktop browser utility to access any web page from any website and easily choose a subset of that web page content to be presented when the page is accessed from the mobile Internet device. This allows subscribers to see only the content they want or need, reducing key strokes and providing an excellent user-friendly mobile Internet experience.

Ability to create custom personal home pages. End-users can create custom web pages based on a default home page delivered to them when service is initially activated.

Ability to send and receive customized web content and personal home pages. The customized web pages can be sent as URL addresses to other parties so that they can have access to them. An example of the utility of this feature is sending and receiving automated business cards containing any type of content.

A unique competitive function of the Universal Bit Broker product is the ability for web content providers to customize the presentation of website content for presentation on mobile Internet devices. Wireless service providers need solutions that allow customized configuration of the content displayed on wireless devices enabling subscribers to easily access and use content with fewer keystrokes.

This function is very powerful and solves the following mobile Internet problems:

User interfaces on mobile wireless devices are typically awkward and unfriendly.

Website content is typically designed for desktop client browsers. Presentation of all of this content on small mobile devices can be crowded, intricate and convoluted.

Users typically need to perform many, many keystrokes through all of the web presented content to get to the content they desire.

Content providers typically have to tailor their websites for a specific presentation technology such as WAP and i-Mode.

Customized website views enable web content providers to easily customize the presentation of their entire websites for presentation on any mobile Internet device regardless of the presentation technology. This will allow content providers access to more subscribers and any subscriber using any mobile Internet device.

The content provider-customized website view function of Universal Bit Broker software provides the following features:

Ability to customize website content presented on any mobile Internet device. Content providers can use a desktop browser utility to easily customize their entire website for specific access by mobile subscribers using any browser technology (e.g., WAP, i-Mode).

Enables service providers to monetize and leverage content providers. A service provider can control access to their subscribers (if they wish) by enabling any content provider worldwide to have access to the service provider's subscriber base. Content providers generally want as many “eyeballs” as possible, and a service provider can supply these to the content providers.

While the invention is described in conjunction with the preferred embodiments, this description is not intended in any way as a limitation to the scope of the invention. Modifications, changes, and variations which are apparent to those skilled in the art can be made in the arrangement, operation and details of construction of the invention disclosed herein without departing from the spirit and scope of the invention.

What is claimed is

1. A method for presenting data in multiple formats in a subscriber network, the method comprising the steps of:
receiving a request from a small screen device for data over a first network using a first communication protocol;
translating the request from the first communication protocol to a second communication protocol;
forwarding the request to a sever having the requested data using the second communication protocol;
receiving the requested data from the sever using the second protocol, wherein the requested data is in a first presentation format; and
reformatting the data in a second presentation format different from the first presentation format.

2. The method according to claim 1 further comprising the step of translating the reformatted data from the second communication protocol to the first communication protocol.

3. The method according to claim 1 further comprising the step of sending the reformatted data to the small screen device.

4. The method according to claim 1 further comprising the step of determining whether a user of the small screen device is a subscriber to the system.

5. The method according to claim 4 further comprising the step of charging the user if the user is not a subscriber to the system.

6. The method according to claim 1 further comprising the step of determining whether the first presentation format can be used by the small screen device.

7. The method according to claim 1, wherein the reformatting step includes the step of using a Mobil Rule Language (MRL) to reformat the data.

8. A system for presenting data in multiple formats in a subscriber network comprising:
a small screen device which transmits a request for data over a first network using a first communication protocol;
a broker processor which receives the request for data from the small screen device, wherein the broker processor translates the request from the first communication protocol to a second communication protocol; and
a sever which receives the request for data using a second communication protocol and transmitting requested data to the broker server using the second communication protocol with the requested data being in a first presentation format;
wherein the broker processor receives the requested data from the sever using the second protocol and reformats the data in a second presentation format different from the first presentation format.

9. The system according to claim 8, wherein the broker processor translates the reformatted data from the second communication protocol to the first communication protocol.

10. The system according to claim 8, wherein the broker processor sends the reformatted data to the small screen device.

11. The system according to claim 8, wherein the broker processor determines whether a user of the small screen device is a subscriber to the system.

12. The system according to claim 11, wherein the broker processor communicates with a billing system to charge the user if the user is not a subscriber to the system.

13. The system according to claim 8, wherein the broker processor determines that the first presentation format can be used by the small screen device.

14. The system according to claim 8, wherein the broker processor uses a Mobil Rule Language (MRL) to reformat the data.

15. The system according to claim 8, wherein the first network is a switching system.

16. The system according to claim 8, wherein the second network is the Internet.

17. The system according to claim 8, wherein the first communication protocol is a Handheld Device Transfer Protocol (HDTP).

18. The system according to claim 8, wherein the second communication protocol is a HyperText Transfer Protocol (HTTP).

19. The system according to claim 8, further including a gateway located between the first network and the second network.

20. A machine-readable medium having processing instructions stored thereon for execution by a processor to perform the method comprising:
receiving a request from a small screen device for data over a first network using a first communication protocol;
translating the request from the first communication protocol to a second communication protocol;
forwarding the request to a sever having the requested data using the second communication protocol;
receiving the requested data from the sever using the second protocol, wherein the requested data is in a first presentation format; and
reformatting the data in a second presentation format different from the first presentation format.
